(19) United States
(12) Patent Application Publication
(10) Pub. No.: US 2011/0258054 A1
(43) Pub. Date: Oct. 20, 2011

(54) Automatic Generation of Bid Phrases for Online Advertising

(76) Inventors: Sandeep Pandey, Santa Clara, CA (US); Vanja Josifovski, Los Gatos, CA (US); Bo Pang, Sunnyvale, CA (US); Andrei Zary Broder, Menlo Park, CA (US); Evgeniy Gabrilovich, Sunnyvale, CA (US); Sujith Ravi, Los Angeles, CA (US)

(21) Appl. No.: 12/693,371

(22) Filed: Apr. 19, 2010

(51) Int. Cl. G06Q 30/00; G06F 17/28

(52) U.S. Cl. 705/14.72; 704/4

(57) ABSTRACT

Automatic generation of bid phrases for online advertising comprising storing a computer code representation of a landing page for use with a language model and a translation model (with a parallel corpus) to produce a set of candidate bid phrases that probabilistically correspond to the landing page, and/or to web search phrases. Operations include extracting a set of raw candidate bid phrases from a landing page, generating a set of translated candidate bid phrases using a parallel corpus in conjunction with the raw candidate bid phrases. In order to score and/or reduce the number of candidate bid phrases, a translation table is used to capture the probability that a bid phrase from the raw bid phrases is generated from a bid phrase from the set of translated candidate bid phrases. Scoring and ranking operations reduce the translated candidate bid phrases to just those most relevant to the landing page inputs.

### FIELD OF THE INVENTION

The present invention is directed towards automatic generation of bid phrases for online advertising.

### BACKGROUND OF THE INVENTION

One of the most prevalent online advertising methods is “textual advertising”, the ubiquitous short commercial messages displayed along with search results, news, blog postings, etc. To produce a textual ad, an advertiser must craft a short creative entity (the text of the ad) linking to a landing page describing the product or service being promoted. Furthermore the advertiser must associate the creative entity to a set of manually chosen bid phrases representing those web queries that should trigger display of the advertisement. For efficiency, given a landing page, the bid phrases are often chosen first and then for each bid phrase a creative entity is produced using a template. Even using templates, an advertisement campaign (for say, a large retailer) might involve thousands of landing pages and tens or hundreds of thousands of bid phrases, hence the entire process can be very laborious.

What is needed are techniques that enable automatic generation of bid phrases for online advertising. Other automated features and advantages of the present invention will be apparent from the accompanying drawings, and from the detailed description that follows below.

### SUMMARY OF THE INVENTION

Methods, apparatus and computer program product for automatic generation of bid phrases for online advertising. The method includes operations for storing a computer code representation of a landing page for use with a language model and a translation model (with a parallel corpus) to produce a set of candidate bid phrases that probabilistically correspond to the landing page, and/or to web search phrases. Operations include extracting a set of raw candidate bid phrases from a landing page, generating a set of translated candidate bid phrases using a parallel corpus in conjunction with the raw candidate bid phrases. In order to score and/or reduce the number of candidate bid phrases, a translation table is used to capture the probability that a bid phrase from the raw bid phrases is generated from a bid phrase from the set of translated candidate bid phrases. A bid phrase seed is not required. Scoring and ranking operations reduce the translated candidate bid phrases to just those most relevant to the landing page inputs.

### BRIEF DESCRIPTION OF THE DRAWINGS

The novel features of the invention are set forth in the appended claims. However, for purpose of explanation, several embodiments of the invention are set forth in the following figures.

FIG. 1 depicts an advertisement server network environment including a bid phrase generation engine in which some embodiments operate.

FIG. 2 shows a screen device with a multi-step procedure for creating a campaign, according to an exemplary embodiment.

FIG. 3 shows a screen device for a campaign set-up procedure for defining keywords for an advertising campaign, according to an exemplary embodiment.

FIG. 4 shows a screen device for a campaign set-up procedure for selecting keywords on the basis of keyword-related metrics for an advertising campaign using computer-assisted techniques, according to embodiments of the invention.

FIG. 5 is a flowchart of a method for automatically creating a campaign, according to one embodiment.

FIG. 6 depicts a server including a candidate bid phrase generation engine and a candidate bid phrase evaluation engine in which some embodiments operate.

FIG. 7A is an annotated chart showing alignment between bid phrases and a landing page using an exemplary parallel corpus, according to embodiments of the invention.

FIG. 7B is an annotated translation table showing probability that a particular landing page phrase is relevant to a bid phrase set, according to embodiments of the invention.

FIG. 8 is a depiction of a system for pre-processing markup for automatic generation of bid phrases for online advertising, according to one embodiment.

FIG. 9 is a flowchart of a method for pre-processing markup for automatic generation of bid phrases for online advertising, according to one embodiment.

FIG. 10 is a flowchart of a system to perform certain functions of CMS-induced ranking for automatic generation of bid phrases for online advertising, according to one embodiment.

FIG. 11 is a flowchart of a system to perform certain functions of keyword extraction for automatic generation of bid phrases for online advertising, according to one embodiment.

FIG. 12 is a flowchart of a system to perform certain functions of a discrimination system for automatic generation of bid phrases for online advertising, according to one embodiment.

FIG. 13 is a depiction of a selector used in development of systems and methods for automatic generation of bid phrases for online advertising, according to one embodiment.

FIG. 14 is a block diagram of a system for automatic generation of bid phrases for online advertising, in accordance with one embodiment of the invention.

FIG. 15 is a block diagram of a system for automatic generation of bid phrases for online advertising, in accordance with one embodiment of the invention.

FIG. 16 is a diagrammatic representation of a network including nodes for client computer systems, nodes for server computer systems and nodes for network infrastructure, according to one embodiment.

### DETAILED DESCRIPTION

In the following description, numerous details are set forth for purpose of explanation. However, one of ordinary skill in the art will realize that the invention may be practiced without the use of these specific details. In other instances, well-known structures and devices are shown in block diagram form in order to not obscure the description of the invention with unnecessary detail.

### Section I: Introduction

In recent years on-line advertising has become a multi-billion dollar industry, a significant portion of which is spent on “textual advertising”. Textual advertising was among the earliest forms of on-line advertising to achieve broad adoption. Textual advertising is seen on-line ubiquitously. For example textual advertising as used herein includes the text-oriented short commercial messages displayed along with other web page materials. In some cases these text-oriented short commercial messages are presented with web search results (e.g. sponsored search advertising) or, in other cases, these text-oriented short commercial messages are displayed along with third-party website pages (e.g. content match advertising).

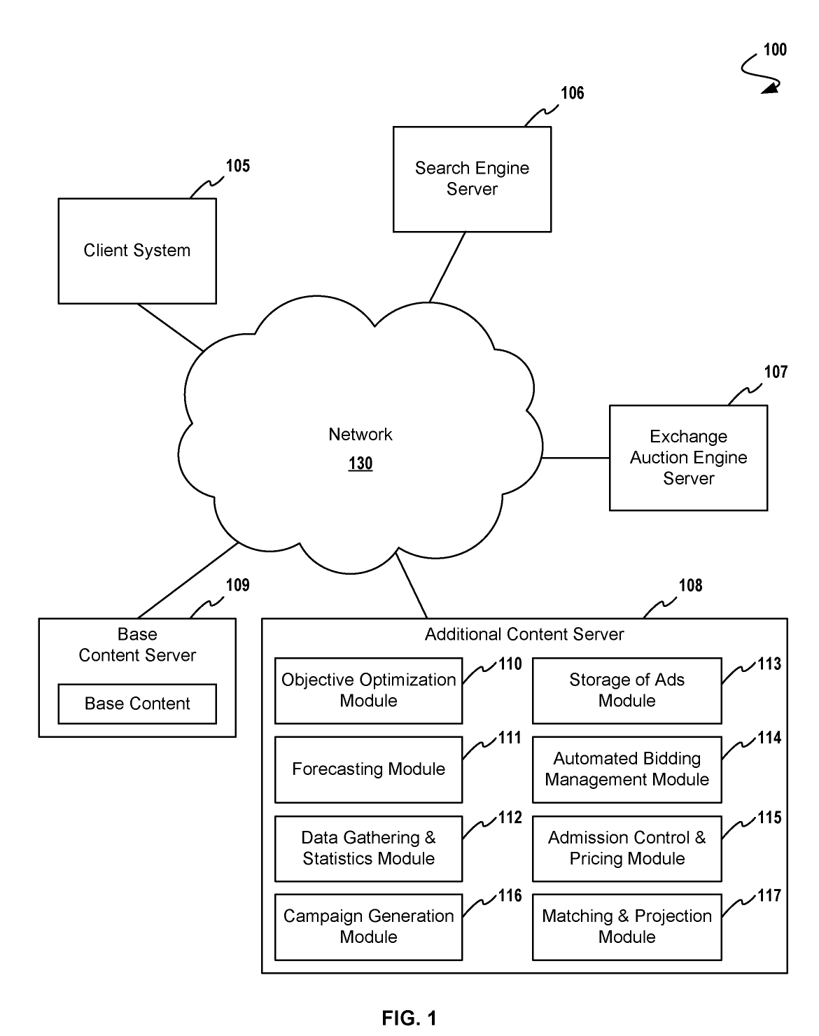

FIG. 1 depicts an advertisement server network environment including a bid phrase generation engine in which some embodiments operate. In the context of Internet advertising, placement of advertisements within an Internet environment (e.g. system 100 of FIG. 1) has become common. By way of a simplified description, an Internet advertiser may select a particular property (e.g. Yahoo.com/Finance, or Yahoo.com/Search), and may create an advertisement such that whenever any Internet user, via a client system 105 renders the web page from the selected property, the advertisement is composited on a web page by one or more servers (e.g. base content server 109, additional content server 108) for delivery to a client system 105 over a network 130. Given this generalized delivery model, and using techniques disclosed herein, sophisticated online advertising might be practiced. More particularly, an advertising campaign might be include highly-customized advertisements delivered to a user corresponding to highly-specific demographics. Again referring to FIG. 1, an Internet property (e.g. an internet property hosted on a base content server 109) might be able to measure the number of visitors that have any arbitrary characteristic, demographic or attribute, possibly using an additional content server 108 in conjunction with a data gathering and statistics module 112. Thus, an Internet user might be ‘known’ in quite some detail as pertains to a wide range of demographics or other attributes.

Therefore, multiple competing advertisers might elect to bid in a market (e.g. an exchange) via an exchange server or auction engine 107 in order to win the most prominent spot, or an advertiser might enter into a contract (e.g. with the Internet property, or with an advertising agency, or with an advertising network, etc) to purchase the desired spots for some time duration (e.g. all top spots in all impressions of the web page empirestate.com/hotels for all of 2010). Such an arrangement and variants as used herein, is termed a contract.

In embodiments of the system 100, components of the additional content server perform processing such that, given an advertisement opportunity (e.g. an impression opportunity profile predicate), processing determines which (if any) contracts match the advertisement opportunity. In some embodiments, the system 100 might host a variety of modules to serve management and control operations (e.g. objective optimization module 110, forecasting module 111, data gathering and statistics module 112, storage of advertisements module 113, automated bidding management module 114, admission control and pricing module 115, campaign generation module 116, and matching and projection module 117, etc) pertinent to contract matching and delivery methods. In particular, the modules, network links, algorithms, and data structures embodied within the system 100 might be specialized so as to perform a particular function or group of functions reliably while observing capacity and performance requirements. For example, an additional content server 108, possibly in conjunction with an auction engine 107 might be employed to define and prosecute a campaign.

As can be inferred from the foregoing, the definition and delivery of online advertising has become more and more sophisticated in recent times. During the same period, the adoption of various forms of on-line advertising have advanced to achieve broad adoption, including small and even very small advertisers. Also, the sophistication of advertisers tends to be directly proportional to the advertiser's size, thus, online advertising networks have developed techniques to facilitate user-friendly creation and management of an advertiser's advertising campaign. For example, an advertising network operator such as Yahoo! might prescribe a series of operations for creating an advertising campaign, and the operations might include the presentation and completion of a series of web pages (e.g. forms, text input fields, pull-downs, and other screen devices).

### Section II: Semi-automatic Creation of an Advertising Campaign

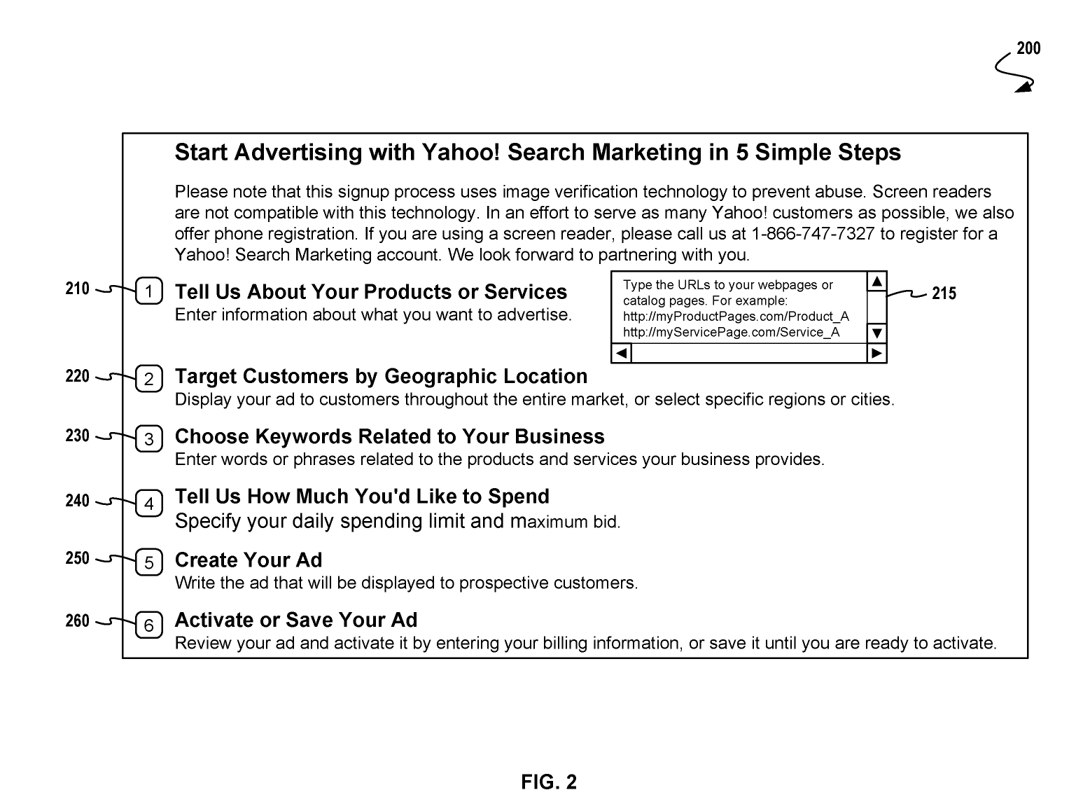

FIG. 2 shows a screen device with a multi-step procedure for creating a campaign, according to one embodiment. As shown, the operations for creating a campaign might include providing some initial information about the products or services to be advertised 210, establishing geographic coverage 220, defining keywords and bid phrases 230, defining advertising spend and budget-oriented parameters 240, creating advertising copy and advertising imagery 250, and activating the campaign 260. In various embodiments, one or more of the operations 210-260 might be performed on the basis of user interaction from a client system 105. In other embodiments, one or more of the operations 210-260 might be performed either fully automatically, or in a computer-aided manner by the additional content server 108. In an exemplary embodiment, the operation providing some initial information about the products or services to be advertised 210 might include a screen device 215 for requesting a user to merely identify a web page (e.g. a landing page) that features the products or services to be advertised. Of course a wide range of information about the subject product or service might be retrieved from the identified web pages, including information on geographic location, appropriate geographic scope, keywords, bid phrases, images and style for creative advertisement generation, and even budget-related parameters.

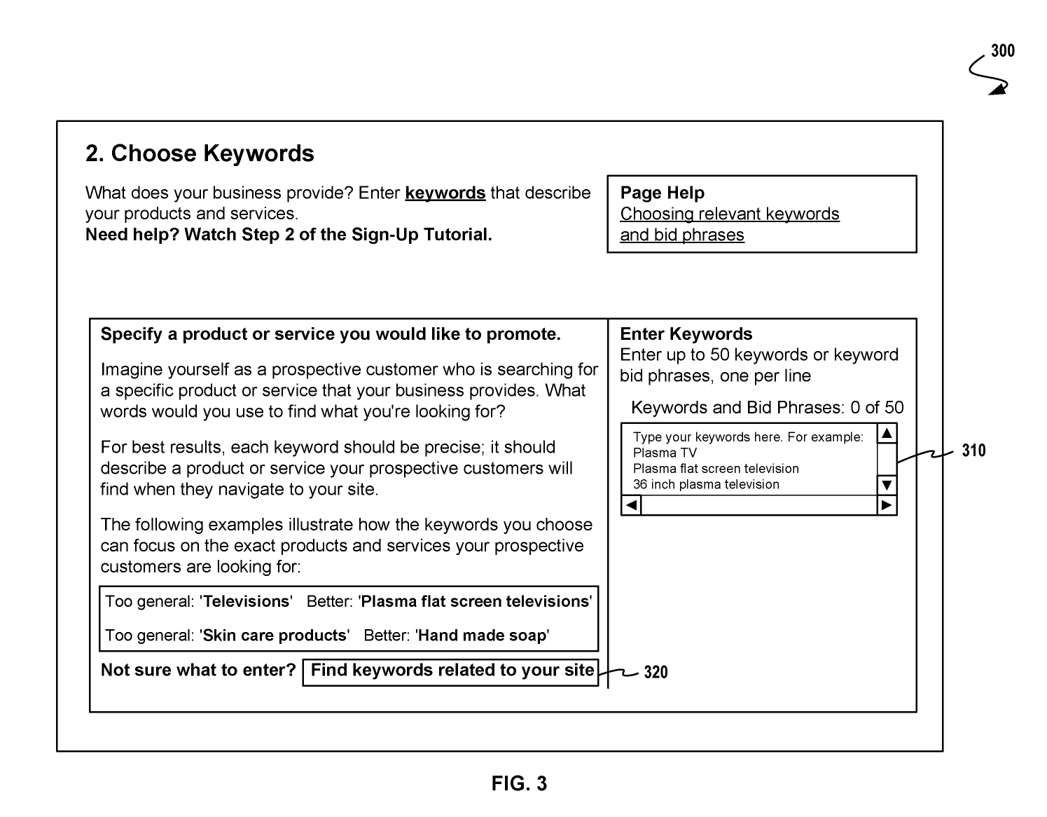

FIG. 3 shows a screen device for a campaign set-up procedure for defining keywords and/or bid phrases for an advertising campaign, according to an exemplary embodiment. As shown, a field, for example the scrolling text field 310 might be populated manually via user input into a text field or other screen device, or it might be populated either fully automatically, or in a computer-aided manner by the additional content server 108, possibly in conjunction with a campaign generation module 116. It should be emphasized that manually entered information (if any) might be used in conjunction with a campaign generation module 116. In fact, heuristics followed by operations in a campaign generation module 116 might employ user-specified information to drive automated or semi-automated assessment of a user-specified product or service web page. Using one or more of the techniques described herein, keywords or combinations of keywords or bid phrases might be gleaned from a prospective advertiser's product or service web pages, auto-populated into the scrolling text field 310 and/or into some underlying database.

As shown, a screen device 300 might provide tips, hints, page help, and/or other resources to aid the user in completing (e.g. in cases of manually entered information) or in accepting (e.g. in cases of computer-aided information population) any auto-populated information. As shown, the button “Find keywords related to your site” 320 might be presented to an advertiser, and clicking the button might invoke one or more operations within a campaign generation module 116.

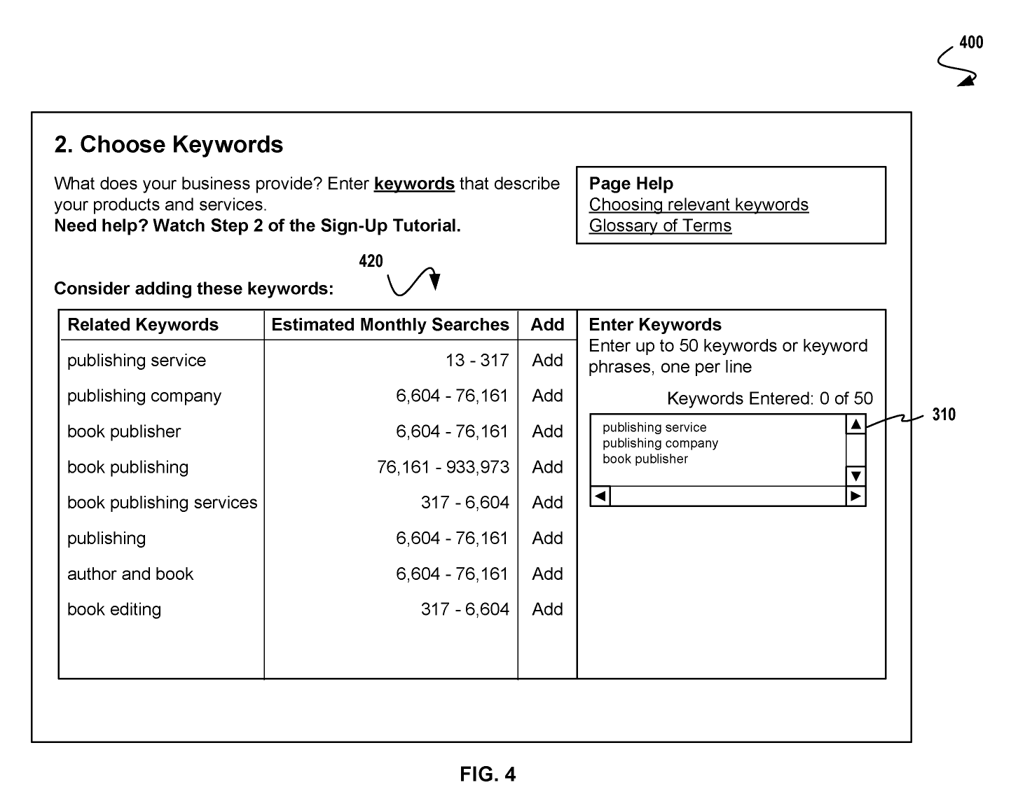

FIG. 4 shows a screen device for a campaign set-up procedure for selecting keywords on the basis of keyword-related metrics for an advertising campaign using computer-assisted techniques, according to embodiments of the invention. As shown, the scrolling text field 310 might be populated manually via a text field or other screen device, or it might be populated either fully automatically, or in a computer-aided manner by the additional content server 108. Furthermore, the scrolling text field 310 might be automatically populated using estimates calculated specifically in regard to an user selections or settings as may have been defined or calculated in any previous operations. It should be noted that given a correspondence between a keyword or bid phrase and its corresponding estimated monthly search magnitude, the number of searches per month for any given keyword or combination of keywords may be calculated, and may be presented in a screen device (e.g. in a tabular form 420).

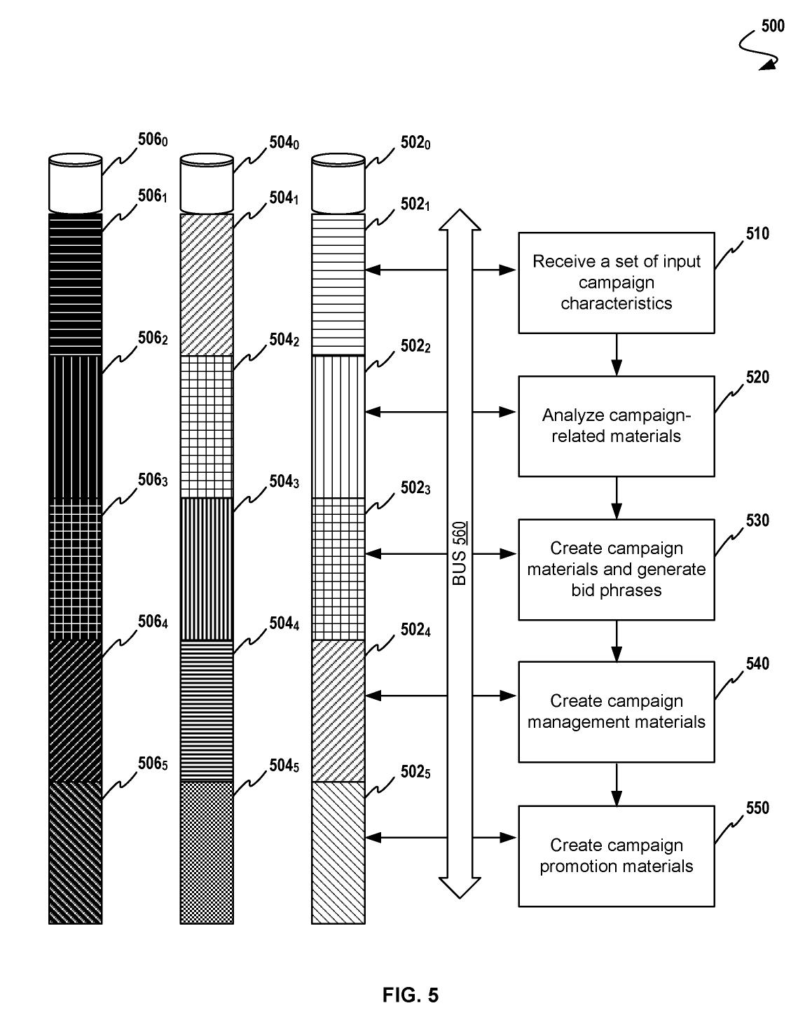

FIG. 5 is a flowchart of a method for automatically creating a campaign, according to one embodiment. As shown, the method 500 proceeds from operation 510 by receiving a set of campaign characteristics (e.g. geographic location, keywords, bid phrases, creative advertising copy, creative advertising graphics, etc). One or more of the received characteristics might be entered manually by a prospective advertiser using any of the screen devices discussed above, or one or more of the characteristics might be automatically calculated using any of the techniques herein. Of course a campaign characteristic might include information regarding a particular product or service that is intended to be advertised. Given at least one campaign characteristic, operation 520 might then analyze any or all campaign-related materials, including any of the aforementioned campaign characteristics, or any other campaign-related materials that might be referred to or inferred from the aforementioned campaign characteristics. In some exemplary cases, a campaign characteristic might include a web page (e.g. a landing page, a landing page URL, a website URL or web page URL), or even a plurality of web pages (e.g. a plurality of landing pages, a catalog or portion of a catalog, etc.) that the advertiser believes describes the product or service, which web pages may be stored in a markup language (e.g. HTML or in XML, or any other markup language). Using any results of the analysis performed in operation 520, the operation to create campaign materials and generate bid phrases 530 might execute. The campaign materials, including any campaign characteristics or parameters derived from any received characteristics, might then be saved by operations 540 and 550 into a data structure for further processing.

When at least some of the campaign characteristics and/or campaign materials have been saved (see operations 550 and 560), a campaign suggestion might be presented to the prospective advertiser. It must be emphasized that the analysis performed to create a campaign suggestion might include analysis of the statistical frequency of occurrence of a set of bid phrases, and might include analysis of the current market price for one or more selected bid phrase within one or more geography, and further, might include a calculation of the number of clicks needed to result in a statistically reliable estimate of an advertiser's prospective return on investment.

Some embodiments estimate of an advertiser's prospective return on investment based on set of bid phrases that are automatically generated using the techniques herein. As shown, any of the operations 510-550 might start at any point in time, and any given operation 510-550 might retrieve information from one or more databases 502₀, 504₀, 506₀, etc, at any point in time over the notional bus 560. Example of techniques used for communication between any of the parallel operations 510-550 over the notional bus 560 include inter-process messaging, TCP/IP or other internet communication protocol, or even possibly including any generation of web services. Moreover, the data within any database 502₀, 504₀, 506₀ might at any point in time be stored in one or more representations, and be physically located in whole or in part in any number of locations, and made accessible to operations 510-550. Thus the operations 510-550 might each operate asynchronously, and might even each be executed on different servers, or possibly using different servers even within any one operation 510-550. The analysis performed to create a campaign suggestion might include processing for automatic generation of bid phrases (see operation 530), which may be associated to one or more display advertisements. In many cases the aforementioned display advertisements may comprise a textual advertisement (e.g. a pure text ad). In other cases, the aforementioned display advertisements may include text in combination with graphics and/or other media and/or text decoration (e.g. typeface, size, style, color, etc).

### Section III: Motivation for Automatic Creation of Bid Phrases

Within the context of manual systems for creation of bid phrase for use in association with a textual advertisement, an advertiser must produce a short creative entity (the text of the ad) linking to a landing page describing the product or service being promoted. Additionally, the advertiser associates the creative entity to a set of manually chosen bid phrases representing those web queries that should trigger display of the advertisement. In some cases, the same set of bid phrases is indirectly used in content match advertising in deciding which ads might be most suited for display on a given page. Under some circumstances where advertisers aim to increase volume of hits, it is desirable for this bid phrase set to be as extensive as possible while yet containing only bid phrases deemed to be relevant to the product or service being promoted.

Within the context of manual systems for creation of bid phrases for use in association with a textual advertisement, the bid phrase creation process is mostly a process of hand-crafting, although there are computer-aided tools to help advertisers choose bid phrases. The majority of these tools, known as “keyword suggestion tools” require an advertiser to enter one or more seed bid phrases. The tools then set about to produce related bid phrases and some tools report additional information such as expected volume of queries, costs, etc. One problem with these tools is their susceptibility to topic drift. That is, the bid phrase set often expands towards phrases with meanings that have little to do with the product or service for which the advertisements are being placed. The larger the seed set, the lower the risk of topic drift, but the creation larger seed sets represent more manual work. The challenge of creating comprehensive bid phrase sets has resulted in development of various approaches for automation.

### Section IV: Introduction to Automatic Creation of Bid Phrases

Since an advertisement campaign (for say, a large retailer) might involve tens of thousands of landing pages, the manual production of even a small seed set is quite laborious and has led to the appearance of computer-aided tools that create bid-phrase sets directly from the landing page.

However, using the landing page as the sole input is problematic since, regardless of how long (e.g. number of words) the promoted product description found at the landing page might be, it is unlikely to include synonymous phrases, and even less likely to contain highly relevant (but possibly rare) queries. Therefore, extractive methods (e.g. pure text extraction) that only consider the words and phrases explicitly mentioned in the given description are inherently limited. Indeed, analysis of a large, real-life corpus of ads showed that as many as 96% of the ads had at least one associated bid phrase that was not present in the landing page.

Thus, disclosed herein are systems and methods for automatic generation of bid phrases for online advertising. More particularly, the systems and methods disclosed herein advance the art of pure textual extraction and make use of materials other than the input landing page.

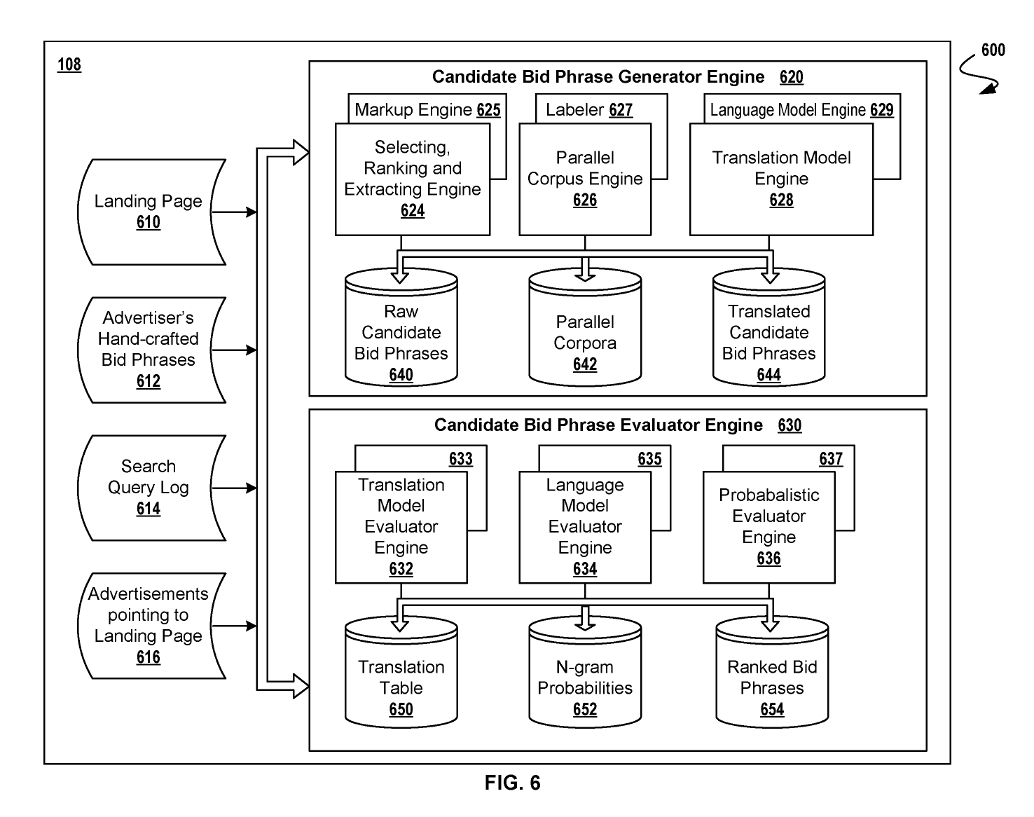

FIG. 6 depicts a server including a candidate bid phrase generation engine and a candidate bid phrase evaluation engine. As shown system 600 may be configured for automatic generation of bid phrases given one or more inputs (e.g. a landing page input 610, an advertiser's hand-crafted bid phrases 612, a search query log 614, and advertisements pointing to a landing page 616). In some embodiments, a candidate bid phrase generator engine 620 might be provided to implement any number of algorithmic techniques to generate bid phrases suitable for the given input(s). A candidate bid phrase evaluator engine 630 is provided to evaluate bid phrases output by the candidate bid phrase generator engine 620. In some embodiments, candidate bid phrases produced by the candidate bid phrase generator engine 620 may be evaluated and/or scored and/or ranked for relevance (e.g. relevant to the content of the landing page input). Further, a candidate bid phrase generator engine 620, possibly in combination with a candidate bid phrase evaluator engine 630, might generate and evaluate bid phrases that are well-formed (e.g. well formed so as to be phrases likely to be used as queries to a search engine).

Some embodiments implement a two-phase approach: In a first phase, candidate bid phrases are generated using one or more techniques, possibly using a selecting ranking and extracting engine 624, a parallel corpus engine 626, one or more translation model engines 628 (e.g. a mono-lingual translation model engine and/or a poly-lingual translation model engine) and/or one or more language model engines 629. As is discussed infra, a candidate bid phrase generator engine 620 is capable of generating phrases not contained within the text of the landing page input 610. In some cases, a candidate bid phrase generator engine 620 is capable of generating phrases including all or parts of unseen phrases (see Construction of a Parallel Corpus in SectionV for a further description of unseen phrases).

In a second phase, the candidates are scored and ranked according to one or more probabilistic evaluator engines 636, possibly in combination with a translation model evaluator engine 632, and/or a language model evaluator engine 634. In some embodiments, a selector function might be provided to select between uses of a translation model evaluator engine 632, which engine favors relevant phrases, versus uses of a bid phrase language model evaluator engine 634, which engine favors well-formed phrases. As is discussed herein, empirical evaluation of the aforementioned two-phase approach based on a real-life corpus of advertiser-created landing pages and associated bid phrases confirms the operation of the two-phase approach. In some cases, the candidate bid phrase generator engine 620, in combination with a candidate bid phrase evaluator engine 630, generates many of the advertiser's hand-crafted bid phrases 612.

As shown, the engines of candidate bid phrase generator engine 620 may produce a database of raw candidate bid phrases 640, one or more parallel corpora 642, and databases of translated candidate bid phrases 644. Similarly, a candidate bid phrase evaluator engine 630 may produce a translation table 650, one or more databases of n-gram probabilities 652, and one or more databases of ranked bid phrases 654.

Various techniques might be used to span the vocabulary mismatch (or vocabulary gap). That is, a system 600 that is capable of generating phrases not contained within the text of the landing page input might use a translation model in order to pose words or phrases suited as bid phrases, yet which words or phrases do not exist in the landing page input 610.

One approach to the problem of a vocabulary gap is to employ a content match system (CMS), which systems are found in content match advertising systems. In a scenario for automatic generation of bid phrases for online advertising using a content match advertising system, advertisements deemed to be relevant to a given landing page are selected using a variety of relevance factors. For example, given a corpus of advertisements and the given landing page, a parallel corpus engine 626 might score advertisements for relevance to the landing page, then use the bid phrases of the top-scoring advertisements to produce bid phrases to be associated to the landing page input 610. The bid phrases generated by this technique might be subsequently evaluated together with other bid phrases generated using any other bid phrase generation technique

Some embodiments offer improvements by implementing the herein disclosed two-phase approach: As earlier described, in a first phase, candidate bid phrases are generated using one or more translation model engines. Translation model engines may be trained using various corpora. In the embodiment discussed below, the translation model engine 628 is trained using a parallel corpus of bid phrases and landing pages.

In one embodiment, a parallel corpus constitutes a large collection of existing ads in parallel with their respective landing pages. In such an embodiment, a bid phrase associated with a given advertisement becomes a “labeled” instance of the form of a pair, denoted as pair=(landing page, bid phrase), possibly using a labeler 627. This labeling may be subsequently used by a translation model evaluator engine 632 to predict the probability that a particular bid phrase may generate a word or phrase given the landing page.

### Section V: Data-Driven Method for Automatic Generation of Bid Phrases for Online Advertising

Let l represent a web page that can potentially be used as a landing page for an ad. Herein are disclosed techniques to automatically generate one or more bid phrases b for l. Treat both b and l as bags of words, that is, b={b₁, b₂, . . . , bₙ}, l={l₁, l₂, . . . , lₘ}, where bᵢ and lⱼ denote words in b and l, repsectively. During this generation task the goal is to achieve: (a) high precision in generated phrases, whereby only highly relevant phrases are generated (i.e. will be deemed to target the advertisement to interested users), and (b) high recall to ensure that the advertisement is allowed to reach to as many interested users as possible. Simultaneous optimization of both these goals offers a natural tradeoff.

As earlier mentioned, phrase b may not exist as a phrase in landing page l; in fact, not all words in b have to come from l. Rather, uses of the aforementioned parallel corpora may generate any number of instances of unique phrase b that do not exist as a phrase in landing page l. It should be recognized that a bid phrase is not necessarily desired to be a gramatically correct sentence; instead, a desired bid phrase more closely resembles a valid search query that could be submitted by a web user.

### Ranking Candidate Phrases

In order to rank candidate phrase b for a landing page l, consider the following generative process: Suppose an advertiser intends to generate a “target” landing page l for a given intent characterized by a “source” bid phrase b. Let Pr(l|b) denote the probability of generating 1 from b. The more relevant phrase b is to page l, the higher Pr(b|l) is, and vice versa. However, modeling Pr(b|l) directly may result in some of the probability mass to be wasted on ill-formed phrases, i.e. ill-formed phrases that are unlikely to be chosen as a bid phrase (e.g. “car on at”). Hence Bayes' law is applied to rewrite Pr(b|l) as:

$$Pr ( b \vert l ) = \frac{Pr ( l \vert b ) Pr ( b )}{Pr ( l )}$$

Thus, the two components Pr(l|b) and Pr(b) may be used independently or in conjunction to model (a) likelihood of bid phrase relevance with the landing page, and (b) to characterize well-formedness (i.e. likelihood a bid phrase is a valid bid phrase). More specifically:
Pr(l|b) is called the translation model (TM) in statistical machine translation (SMT) literature, since it gives the translation probabilities from bid phrases to landing pages (e.g. learned using a parallel corpus). In contrast to modeling Pr(b|l) directly, the factoring into Pr(l|b) Pr (b) allows the translation model to concentrate the probability mass on the relevancy between landing pages and well-formed bid phrases.
Pr(b) is called the bid phrase language model (LM) since it characterizes whether a phrase is likely to be a valid bid phrase. Hence, phrases like “car rental” will be preferred over phrases like “car on at”. This distribution can be estimated on a corpus of phrases alone, which is usually easier to obtain in large quantities than a parallel corpus needed to learn the translation model.

The following sections examine how to estimate both Pr(l|b) and Pr(b). In particular is disclosed how estimates of Pr(l|b) and Pr(b) may be used to enhance techniques for bid phrase generation that are based solely on keyword.

### Translation Models

A translation model may be used to bridge the vocabulary gap so as to score words in a bid phrase that are relevant to the landing page—even though the subject bid phrase does not appear as part of the landing page.

### Construction of a Parallel Corpus

Techniques disclosed herein construct a parallel corpus with given b→l pairs, which parallel corpus may then be used to learn a translation model for estimating Pr(l|b) for unseen (b,l) pairs.

Given: A training corpus Lₜᵣₐᵢₙ with a collection of landing pages along with bid phrases provided by advertisers.

Construction: For each landing page l and each bid phrase b associated with it, generate a parallel training instance from this (bid phrase, landing page) pair as:

b₁b₂ . . . bₙ→l₁l₂ . . . lₘ

For example, a landing page discussing topics related to the actress Dunst may contain the words (kirsten, dunst, film, gossip, maxim, girl etc), and the advertiser-generated bid phrases may include “kirsten dunst movie”, “kirsten dunst interview”, “kirsten dunst story”, etc. Each of these bid phrases is paired with the landing page words to create a new parallel training instance for the translation model as follows:

kirsten, dunst, movie→kirsten, dunst, film, gossip . . .

kirsten, dunst, interview→kirsten, dunst, film, gossip . . .

kirsten, dunst, story→kirsten, dunst, film, gossip . . .

More parallel corpora spanning the vocabulary gap may be constructed and used as parallel training instances as follows: For a given landing page, process and use the content within the advertisements that point to the landing page (e.g. advertisement description, advertisement title, etc) and create the new pairs (e.g. bid phrase, advertisement word content) as parallel training instances. Such advertisements and the landing pages to which the advertisements point are plentiful in the public domain; thus a large number of parallel training instances may be included in the training set.

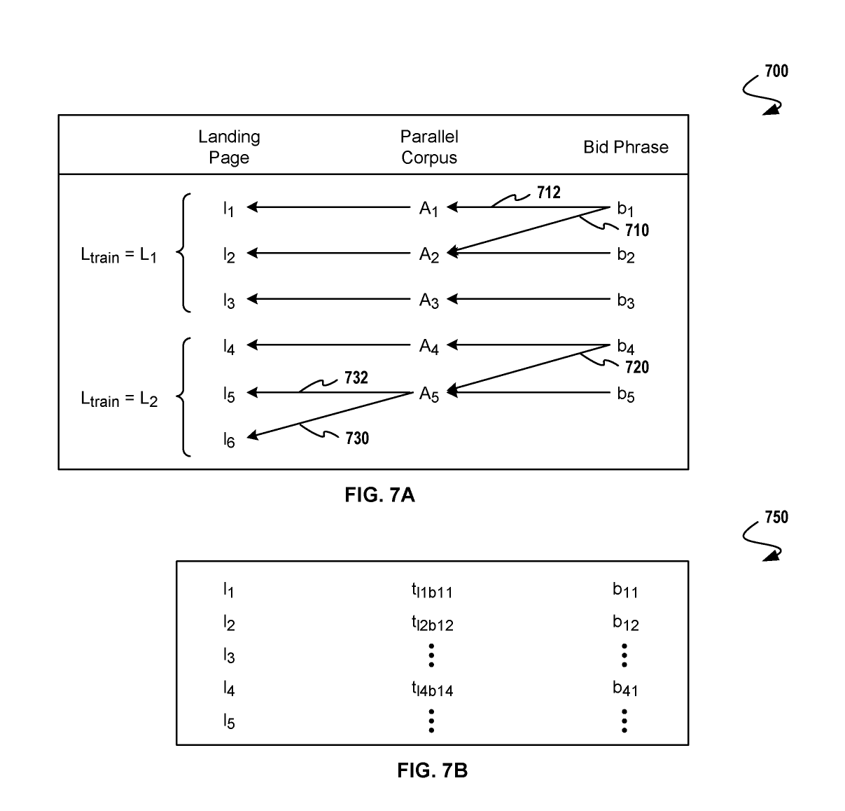

FIG. 7A is an annotated chart showing alignment between bid phrases and a landing page using an exemplary parallel corpus. As shown, table 700 includes a column of bid phrases (b₁b₂ . . . bₙ), and a column of words or phrases (l₁l₂ . . . lₘ) found in the corresponding landing page (LₜᵣₐᵢₙL₁, Lₜᵣₐᵢₙ=L₂, etc), and a column of associated words or phrases (A₁, A₂, A₃, etc) found in the parallel corpus. Of course a particular bid phrase (e.g. b₁) might have a pairing with multiple associated words or phrases. In this example, the bid phrase b₁ is paired with both A₁ and A₂ (see association indicator 712 and association indicator 710). Similarly, a particular associated word or phrase might have a pairing with multiple associated words or phrases. In this example, the associated word or phrase A₅ is associated with both l₅ and l₆ (see association indicator 732 and association indicator 730).

### Construction of a Translation Table

For each bᵢεb, let t(lⱼ|bᵢ) be the probability that lⱼ is generated from bᵢ. One estimate for Pr(l|b) is given as:

$$Pr ( l \vert b ) ∝ {\prod }_{j}^{ } {\sum }_{i}^{ } t ( {l}_{j} \vert {b}_{i} )$$

Each estimate (a percentage) may be used to label any of the aforementioned pairs as discussed in FIG. 7A. The resulting table t is termed as the translation table. The table t characterizes the likelihood of a token in a landing page being generated from a token in a bid phrase. Having generated a translation table for all words in the bid phrase vocabulary and all words in the landing page vocabulary (note that empirically many pairs may have zero translation probability), the translation table can be used to estimate Pr(l|b) for (phrase, page) any pair.

FIG. 7B is an exemplary, partially populated and annotated translation table showing probability that a particular landing page phrase is relevant to a bid phrase set. As shown, table 750 includes a column of pairs (b₁₁b₁₂ . . . bₙₚ), and a column of words or phrases (l₁l₂ . . . lₘ) found in the corresponding landing page (i.e. from Lₜᵣₐᵢₙ=L₁, Lₜᵣₐᵢₙ=L₂, etc), and a column of estimates expressed as a percentage a (t_{11b11}, t_{12b12}, etc) referring to the likelihood that a token in a landing page (e.g. 1₁) would be generated from a token in a bid phrase of the corresponding pair (e.g. b₁₁b₁₂ . . . bₙₚ). As earlier mentioned, a particular bid phrase (e.g. b₁) might have a pairing with multiple associated words or phrases, thus giving rise to the nomenclature for a pair that includes a second index referring to the enumeration of the pair (e.g. the p in bₙₚ).

Recall the kirsten dunst example given above. Suppose it were known that the word film in the landing page could be generated (i.e. with a non-zero likelihood) by the word movie in the bid phrase; or, following the terminology in machine translation, the word film should be aligned to the word movie. Then, given the alignment information for all occurrences of movie in the parallel corpus, estimating t(film|movie) can be calculated as follows: Count the number of times movie is aligned to film, and the number of times movie is aligned to any word in landing pages, and compute the fraction between the two.

In some cases, the word-level alignment probabilities are given in the training data (e.g. probability values t(·|bᵢ)). In such a case, given an estimate of the probability of different alignment assignments, compute the expected values of t(lⱼ|bᵢ) instead. For example, assume each word in b has equal probability of being aligned to all words in the landing page paired with it in the parallel corpus. A translation model computed based on this alignment would be similar to what is obtained from straightforward co-occurrence analysis. In some cases, the translation table is learned through an expectation maximization (EM) algorithm where the word-level alignments are treated as hidden variables. Both t values and alignments can be initialized with uniform distributions, and may be thereafter iteratively refined via EM. Of course a translation table may be populated using any of the techniques herein.

### Null Tokens

The concept of null tokens are introduced to account for words that do not align well with any words on the other side. In embodiments the present invention, selecting and marking null tokens in bid phrases is particularly useful as null tokens account for those lⱼ that are known to be (or suspected to be) irrelevant or at least not closely related to b. Thus t(·|bᵢ) contains less probability mass on irrelevant lⱼ than would be the case without selecting and marking null tokens before calculating the translation table for t(·|bᵢ).

Consider the following example using a parallel corpus:
Honda→Best car dealer
mp3 player→Buy a new ipod
Honda→Buy a new car
mp3 player→Best price on nano
   Applying the aforementioned techniques would result in the following translation table:

TABLE 1

Translations

| bᵢ | lⱼ | t(lⱼ\|bᵢ) | lⱼ | t(lⱼ\|bᵢ) |
|---|---|---|---|---|
| mp3 | on | 0.18 | price | 0.18 |
| | nano | 0.18 | a | 0.07 |
| | ipod | 0.18 | Best | 0.07 |
| | price | 0.18 | new | 0.07 |
| Honda | car | 0.49 | a | 0.07 |
| | dealer | 0.25 | Best | 0.07 |
| | a | 0.07 | new | 0.07 |
| null | a | 0.24 | car | 0.03 |
| | Best | 0.24 | dealer | 0.01 |
| | new | 0.24 | nano | 0.00 |
| | Buy | 0.24 | ipod | 0.00 |
| | car | 0.03 | on | 0.00 |

Note that most of the uninformative words in the landing pages are primarily accounted for by the null token so that the translation table for real words can concentrate the probability mass on the more relevant words like car or ipod. When the translation probabilities are estimated as conditional probabilities computed directly from the co-occurrence information, that

is,

$$Pr ( {l}_{i} \vert {b}_{j} ) = \frac{count ( {l}_{j} , {b}_{i} )}{count ( {b}_{i} )} ,$$

then

$$Pr ( Best \vert Honda ) = \frac{1}{2} Pr ( car \vert Honda )$$

is obtained. In contrast, in the translation table computed through EM, t(car|Honda) is much bigger than t(Best|Honda). Thus, the introduction of null tokens, together with the iterative refinement of the parameters through EM, produce a more robust translation table than what would be produced directly through simple co-occurrence analysis.

### Source Markup Weighting Considerations

Some words in a landing page are more important than others. For instance, given a landing page provided as a page of markup (e.g. an HTML page, an XML document, etc), words that appear in titles, headings, etc. are usually more salient features of the page. To emphasize the importance of such words (in both learning and prediction phases), a markup weight wⱼ is associated for all lⱼεl. For instance, a low markup weight for all normal content words and a higher markup weight for words with salient markup tags (e.g. HTML<HEAD>, etc) can be assigned.

Pre-processing the Source Materials Landing Pages using Markup

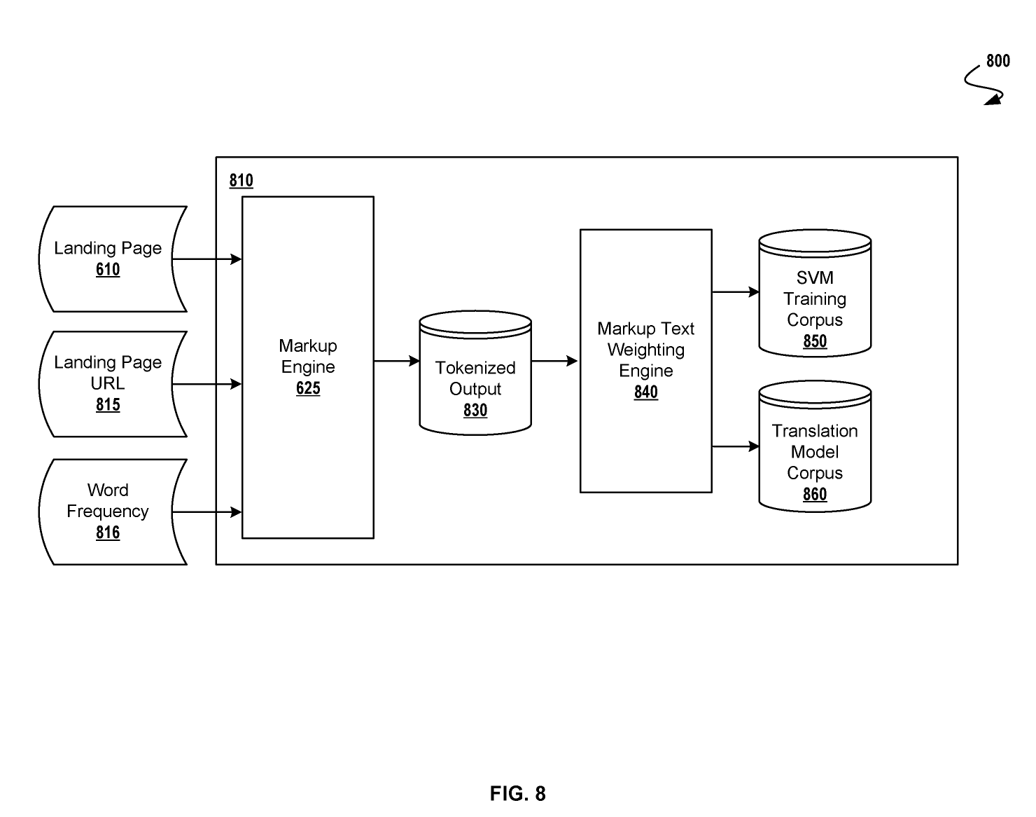

FIG. 8 is a depiction of a system 800 for pre-processing markup for automatic generation of bid phrases for online advertising. Inasmuch as certain content within landing page(s) might be more relevant than other content, landing page input 610 might be pre-processed within a markup engine 625. In some embodiments, a landing page is first parsed for syntactical correctness (i.e. depending on the markup language) and characters are normalized with respect to other operations (e.g. lower-cased). Stop words (e.g. connective words such as ‘a’, ‘the’, prepositions, pronouns, etc.) are removed and the content is tokenized (e.g. to separate words from punctuation, to normalized hyphenation, etc.) and the resulting text is stored as tokenized output 830. Similarly, such pre-processing might be applied to the landing page URLs 815 corresponding to the landing page(s) and added to the tokenized output 830. A markup text weighting engine 840 might then be used for weighting words in the tokenized output 830. As an example, for each word lⱼ in the tokenized output, compute a markup weight associated with the word:

$${w}_{j} = \frac{{weight}_{tag} \times {f}_{j}}{log ( {N}_{d} )}$$

where:
weight_{tag} is a markup weight assigned to each word depending on its markup tag type and/or position,
fⱼ is the frequency of the word on the given landing page, and

N_{d} is the number of documents on the web that contain the word (e.g. N_{d} retrieved from word frequency input 816).

Strictly as an example, the value of weight_{tag} might be set to a relatively higher value of 10 for words appearing in the landing URL or on the web page within tags such as <title>, <keywords>, <hl>, etc., and might be set to Weight_{tag}=1 for words appearing elsewhere on the web page. Relatively unimportant words (e.g. as determined by the value of wⱼ) that occurr on the page might be filtered out using a threshold on the markup weight wⱼ (e.g. filter out words with wⱼ<0.5). In some embodiments, this operation selects only the top M percent of the highest weighted words found within a selected markup tag rather than filter out based on an absolute value of wⱼ. After processing in the markup text weighting engine 840 completes, thus producing a representation of the weighted output, an SVM training corpus 850 may be used to train a discriminative ranking model using SVM^{rank} (described infra; also see Lₜᵣₐᵢₙ). Also, a representation of the weighted output from markup text weighting engine 840 may be provided as a translation model corpus 860, and used as an input to the parallel corpus engine 626 to construct a parallel corpus to train the translation model.

Of course, the system 800 for pre-processing markup for automatic generation of bid phrases for online advertising is an exemplary embodiment, and some or all (or none) of the operations mentioned in the discussion of system 800 might be carried out in any environment.

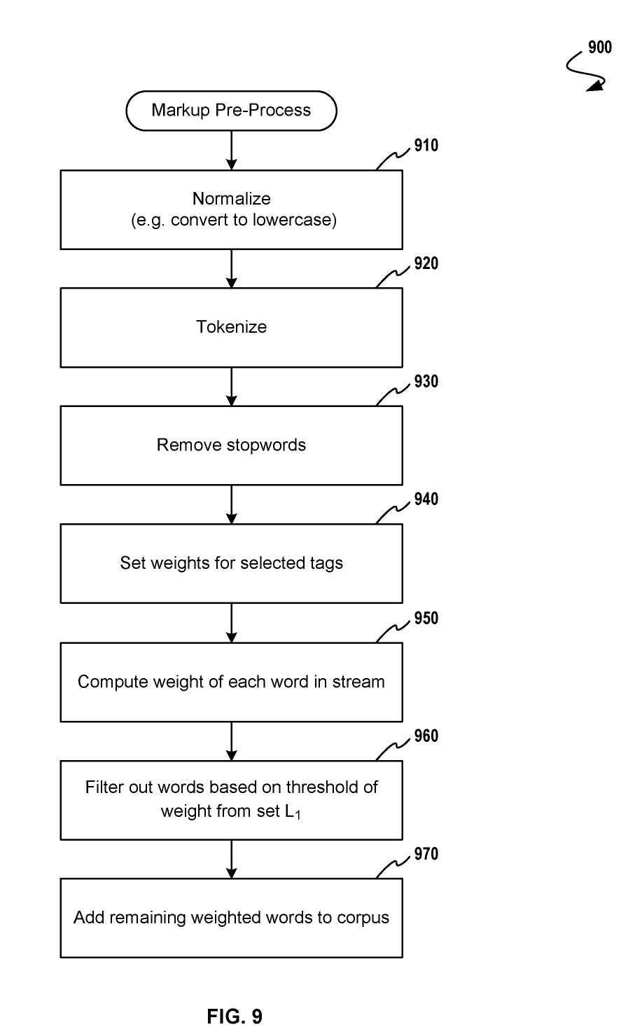

FIG. 9 is a flowchart of a method 900 for pre-processing markup for automatic generation of bid phrases for online advertising. As shown, the method commences by normalizing the inputs (see operation 910) and tokenizing the input (see operation 920). The inputs to operation 910 may include a landing page input 610, or advertisements pointing to landing pages 616, or any other inputs supplied in a markup language. Certain stopwords may be removed from the tokenized stream (see operation 930). In another operation, possibly in an offline/static operation, weights are assigned to selected tags (see operation 940). The value assigned to a particular selected tag is dependent on the type of markup. For example, in HTML the tag <HEAD> has a particular and standardized meaning. Conversely, in XML, the tag <HEAD> may have a different meaning, and a different weight. The tokenized stream is then pre-processed to compute the weights of each remaining word in the stream (see operation 950) and possibly remove words based on a threshold (see operation 960). Operation 950 and operation 960 might be performed sequentially (as shown) using two or more passes through the tokenized stream, or they might be processed in an interleaved matter, depending on the algorithm for filtering. The weighted words may be passed to another method, or might be used to initialize a corpus, or might be added to a corpus (see operation 970).

### Using Markup Weights in Construction of a Translation Table

Given the markup weights, the formula for Pr(l|b) may be modified as follows:

$$Pr ( l \vert b ) ∝ {\prod }_{j}^{ } {( {\sum }_{i}^{ } t ( {l}_{j} \vert {b}_{i} ) )}^{{w}_{j}}$$

Noting the exponent term wⱼ, this effectively imparts higher value to important words in a landing page (i.e. words with high scores), which more important words then account for more of the translation probability mass. In some embodiments, the difference in sizes between the bid phrases (e.g. a few words) and the landing pages (e.g. scores or hundreds of words) may be considerable. Accordingly, it is likely that a given bid phrase will be aligned with multiple words in landing pages, thus dispersing the probability mass of t(·|bᵢ). Even in the presence of the null token, one null token is unlikely to account for all irrelevant words on the page since the distribution of t(·|null) will be very thinly spread out. One approach is to insert multiple null tokens into the bid phrase. An alternative approach is to reduce the set of lⱼ to top n tokens with highest wⱼ weight scores or to reduce the set of lⱼ to the top M percent of the weighted tokens. Following such embodiments, a translation table 650 may be produced, the translation table containing triplet entries (b,lⱼ, t(lⱼ|bᵢ)).

### Bid Phrase Language Model

Much of the foregoing disclosure has focused on the uses of a translation model within a system for automatic generation of bid phrases for online advertising, and the foregoing techniques involving the translation models result in generation of bid phrases that include words or phrases that do not appear in the input. That is, through the use of a parallel corpus, new bid phrases are generated and, furthermore, such techniques do not require a bidphrase ‘seed’ to be supplied by the advertiser.

However, in addition to the use of new (e.g. formerly unseen) bid phrases, advertisers desire bid phrases that match popular web search queries so as to increase the chance of their ads being shown and users clicking on their ads more often. Search query logs are therefore good sources of de-facto well-formed bid phrases. In embodiments discussed below, language model modules (e.g. language model engines 629, bid phrase language model evaluator engine 634) may be trained on a large-scale web search query log.

In embodiments involving the bid phrase language model evaluator engine 634, the probability function Pr(b) is instantiated with an n-gram language model, an n-gram being a de-facto well-formed bid phrase.

Since web queries are typically short, a relatively short-run n-gram (e.g. bigram) model will capture most of the useful co-occurrence information. A n-gram model may be smoothed by an m-gram model where 0<m<n (e.g. unigram) model, that is, some embodiments backoff to an m-gram model so that n-grams not observed in the training data do not get zero probability. The language model may be estimated on a large query corpus Q (i.e. Q containing queries from a web search log). More specifically,

$$Pr ( b ) = {\prod }_{i}^{ } Pr ( {b}_{i} \vert {b}_{i - 1} ) , \\ where$$

$$Pr ( {b}_{i} \vert {b}_{i - 1} ) = {λ}_{1} f ( {b}_{i} ) + {λ}_{2} f ( {b}_{i} \vert {b}_{i - 1} )$$

with λ₁+λ₂=1. Now, let c(bᵢ,bⱼ) be the number of times bᵢbⱼ appear as a sequence in Q:

$$f ( {b}_{i} \vert {b}_{i - 1} ) = \frac{c ( {b}_{i - 1} , {b}_{i} )}{{\sum }_{j} c ( {b}_{i - 1} , {b}_{j} )}$$

Let c(bᵢ) be the number of times bᵢ appears in Q, and |V| be the vocabulary size of Q (i.e. the number of unique tokens in Q). Then f(bᵢ) can be estimated with add-one smoothing:

$$f ( {b}_{i} ) = \frac{c ( {b}_{i} ) + 1}{{\sum }_{j} c ( {b}_{j} ) + \vert V \vert}$$

Thus, such a bid phrase language model prefers phrases with tokens that are likely to appear in queries, as well as those containing pairs of tokens that are likely to co-occur in the query log. Wherever word order is not considered particularly important in bid phrases, it is possible to adapt the n-gram model so that it is order insensitive; thus, in some embodiments, if (for example) bᵢbⱼ occurs more often than bⱼbᵢ, this order preference is preserved in the model.

### Section VI: Additional Techniques

Generating Candidate Phrases Using the Bid Phrase Language Model in Combination with Other Models

In theory, candidate phrases can be all possible phrases found in query log Q. However, to rank all bεQ according to Pr(l|b) Pr(b) may not be practical for a large Q. One possibility to limit the number of phrases bεQ is to consider only phrases aligned with the landing page. However, as mentioned earlier, advertisers often desire bid phrases that do not appear as a phrase on the landing page. So, in addition to considering candidates directly aligned with the landing page using the language model (i.e. without use of a parallel corpus), some embodiments also consider phrase generation strategy using the translation models introduced above.

Now, using bid phrase candidates (referred to as the candidate set B_{LP}), a further set of bid phrases (e.g. ranked bid phrases 654) might be formed and ranked as follows:

Pick the n_{P} most important words from the landing page by selecting those with highest wⱼ scores, where wⱼ incorporates the markup weights described above. Then, for each word nᵢεnₚ, select the nₜ most likely translations from a translation table constructed over nₚ. These “translated” words are then combined into all possible permutations to form the candidate phrases generated by the translation model (referring to this candidate set as B_{TM}_{_{gen}}). Additionally, as an optional operation, generate smaller n-gram sequences from these phrases and add them to the candidate pool.

The foregoing discloses several generative model-based techniques, some of which rely on one or more translation models and one or more language models to generate and rank bid phrases. Other techniques are envisioned and reasonable, and may be used in place of, or in addition to the foregoing techniques.

### Using Content Match Systems for Bid Phrase Generation

A content match system (CMS) may be used to find the most relevant ads for a given landing page. A content match system might perform this task by converting the landing page into a weighted feature vector, where a feature can correspond to a word or phrase on the landing page and its weight denotes the significance (e.g. relevance) of the feature. Similarly, advertisements are converted into feature vectors. Then, the relevance of a landing page as compared to an advertisement is computed by applying a similarity function (e.g. cosine, Jaccard) on their corresponding feature vectors. It is possible to generate bid phrases aligned to a landing page using such a content match system and an existing corpus of advertisements with bid phrases. One selection technique may apply CMS weighted feature vector calculations on the landing page; another technique may apply CMS weighted feature vector calculations on the advertisement corpus, then compare (e.g. using a similarity function) so as to obtain the top matched advertisements from the advertisement corpus. In another selection technique, the top matched advertisements are selected (i.e. ranked and matched) based on their bid values. In yet another selection technique, a content match system determines the most “appropriate” bid phrase. Applying one or more of the foregoing selection techniques results in a set of bid phrases, denoted by B_{CMS}. Next, the bid phrases present in the set B_{CMS} are ranked. One ranking technique is termed CMS-induced ranking. CMS-induced ranking ranks the bid phrases in the order they occur in the ranked list as computed using any one or more of the foregoing CMS selection techniques that take both bid values and relevance scores into account. Another ranking technique is termed frequency-based ranking. Frequency-based ranking ranks the phrases based on their number of occurrences in the set B_{CMS} such that the most common bid phrase is put at the top, the next most common bid phrase is put just below that, and so on.

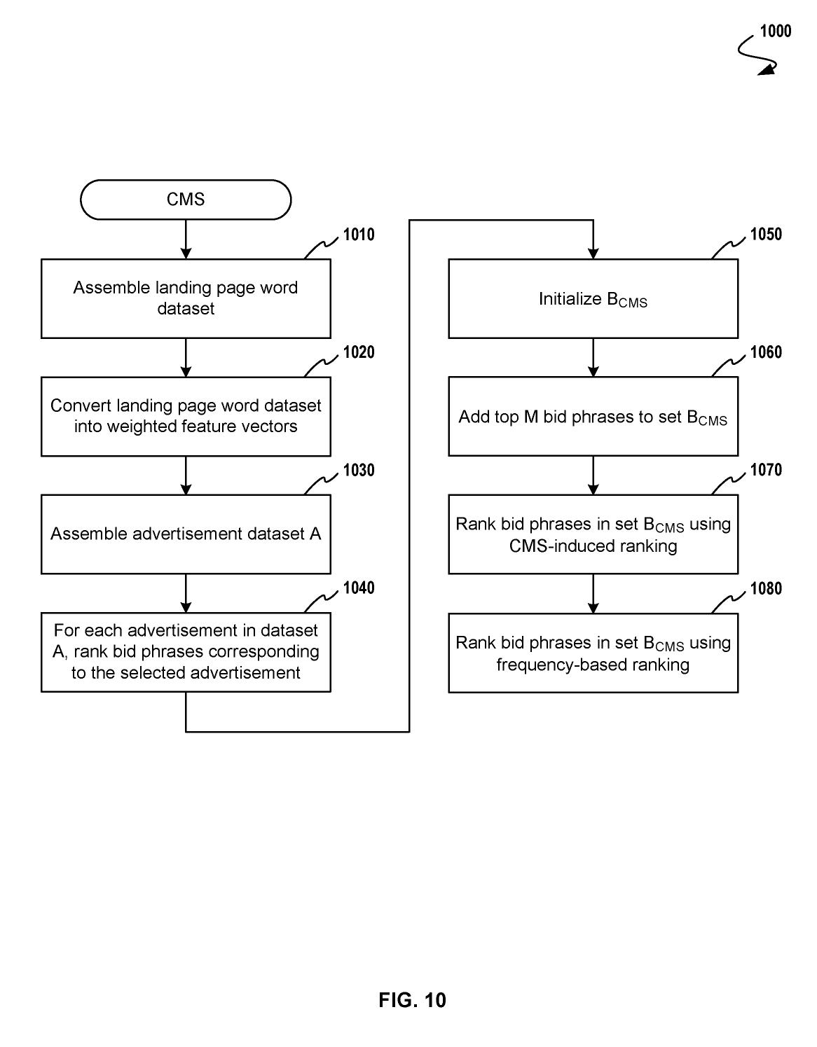

FIG. 10 is a flowchart of a system to perform certain functions of CMS-induced ranking for automatic generation of bid phrases for online advertising. As an option, the present system 1000 may be implemented in the context of the architecture and functionality of the embodiments described herein. Of course, however, the system 1000 or any operation therein may be carried out in any desired environment. As shown, system 1000 comprises a series of operations used in the creation of a set of bid phrases, namely set B_{CMS}. A given landing page is assembled into a landing page dataset, possibly including stripping the markup from the page, leaving only content words (see operation 1010). Then convert the landing page word dataset into weighted feature vectors (see operation 1020). After assembling an advertisement dataset (see operation 1030), for each advertisement in the dataset, rank bid phrases corresponding to the selected advertisement (see operation 1040). Create a data structure for set B_{CMS} (step 1050) and add the top M bid phrases to set B_{CMS} (see operation 1060). Rank bid phrases in B_{CMS} using any one or more of the CMS-induced ranking techniques discussed above (see operation 1070). Alternatively, rank bid phrases in B_{CMS} using frequency-based ranking (see operation 1080).

### Extraction-based System

Another approach to bid phrase generation is termed keyword extraction. Both words and phrases may be generated using this approach. Various embodiments of this approach use two phases where bid phrase candidates are generated in the first phase and the evaluation and ranking is performed in the second phrase. In particular, first pre-process and tokenize the landing page and the landing page URL and extract words and phrases (e.g. n-gram word sequences of length <=5) from the page and URL. Add these as candidates to a bid phrase pool. Then, compute a relevance weight

$${w}_{k}^{′} = \frac{{f}_{k}}{log ( {N}_{d} )}$$

for each word bₖ from the bid phrase pool, where fₖ represents the frequency of the word within the bid phrase pool and N_{d} is the number of documents on the web that contain the word. In some embodiments, a bid phrase is represented as a relevance weight vector. In addition, low-weighted candidates are filtered out by using a threshold on the relevance weight of words that can appear in a phrase selected from the bid phrase pool. Next, the landing page is represented in markup weight vectors (based on the markup

$${w}_{j} = \frac{{weight}_{tag} \times {f}_{j}}{log ( {N}_{d} )}$$

as earlier described) and the similarity (e.g. cosine similarity) computed between the landing page markup vector and the relevance weight vector. The similarity scores are used to induce a ranking on the bid phrase set for a given landing page.

In another embodiment of an extraction-based system, the extracting performed by a selecting ranking and extracting engine 624, expressly excludes advertiser s hand-crafted bid phrases 612.

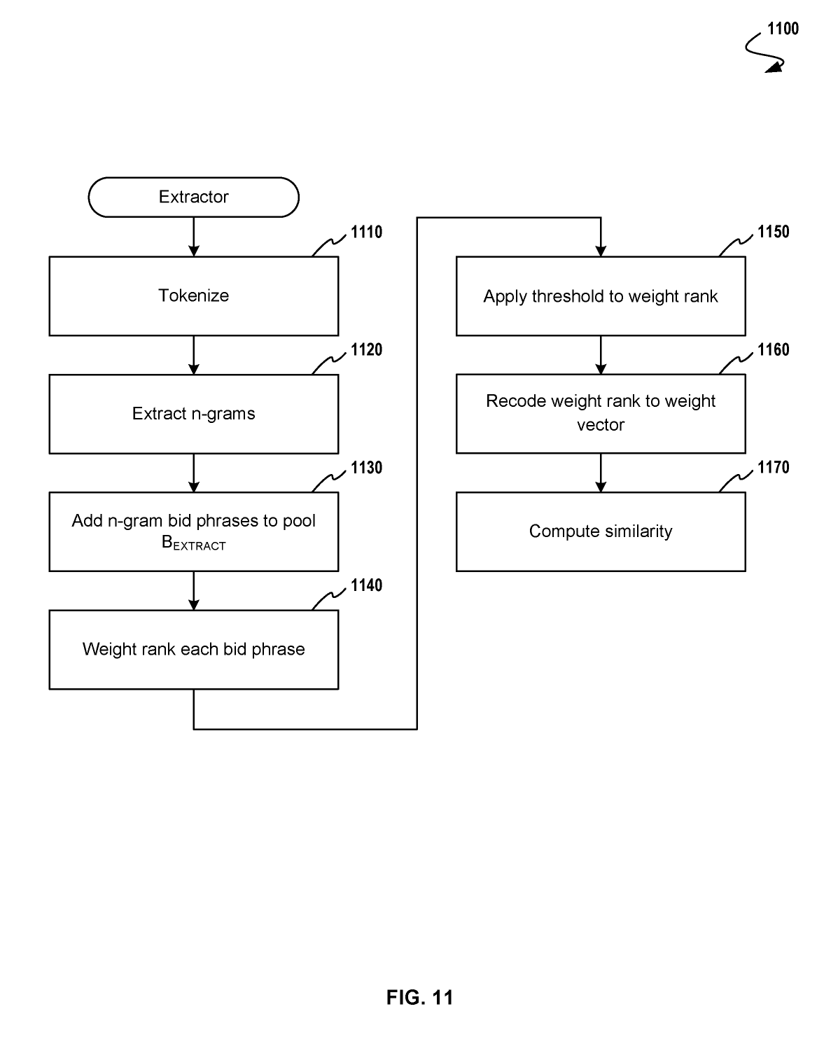

FIG. 11 is a flowchart of a system to perform certain functions of keyword extraction for automatic generation of bid phrases for online advertising. As an option, the present system 1100 may be implemented in the context of the architecture and functionality of the embodiments described herein. Of course, however, the system 1100 or any operation therein may be carried out in any desired environment. As shown, system 1100 comprises a series of operations used in the creation of a set of bid phrases using an extraction-based system. The series of operations may commence by tokenizing the input (e.g. a landing page, a landing page URL) and extracting n-grams from the resulting token stream (see operation 1110 and operation 1120). The extracted n-gram bid phrase candidates are then added to a pool (see operation 1130) and each n-gram bid phrase found in the pool is weight ranked (see operation 1140), after which a threshold is applied to the weight rank (see operation 1150) for eliminating low-weighted n-gram bid phrases from the pool (see operation 1160). An n-gram bid phrase found in the pool may be re-coded so as to be represented as markup weight vectors (see operation 1160). Once represented as markup weight vectors, the similarity of any n-gram bid phrase in the pool may be compared for similarity to the landing page (see operation 1170). The similarity scores are used to induce a ranking on the bid phrase set for a given landing page.

### Discriminative System

Another approach to bid phrase generation and ranking is termed a discriminative system. The phrase candidates (e.g. translated phrase candidate bid phrases 644) are supplied to the discriminative system using any one or more of the other candidate generation approaches.

Given a bid phrase candidate for a landing page, the discriminative system computes various features to do the ranking. One possible feature set includes features such as a word overlap score, a cosine similarity score of the candidate bid phrase with the landing page, etc. Another possible feature is to take into account the position of a word from a bid phrase as it appears on the landing page.

Some embodiments use a corpus of landing pages for training together with bid phrases, and train a ranking model using SVM^{rank} with a linear kernel to set feature weights. Then, given a test landing page and set of candidate bid phrases (along with their features), the trained model can be used to rank the bid phrases with respect to the given page.

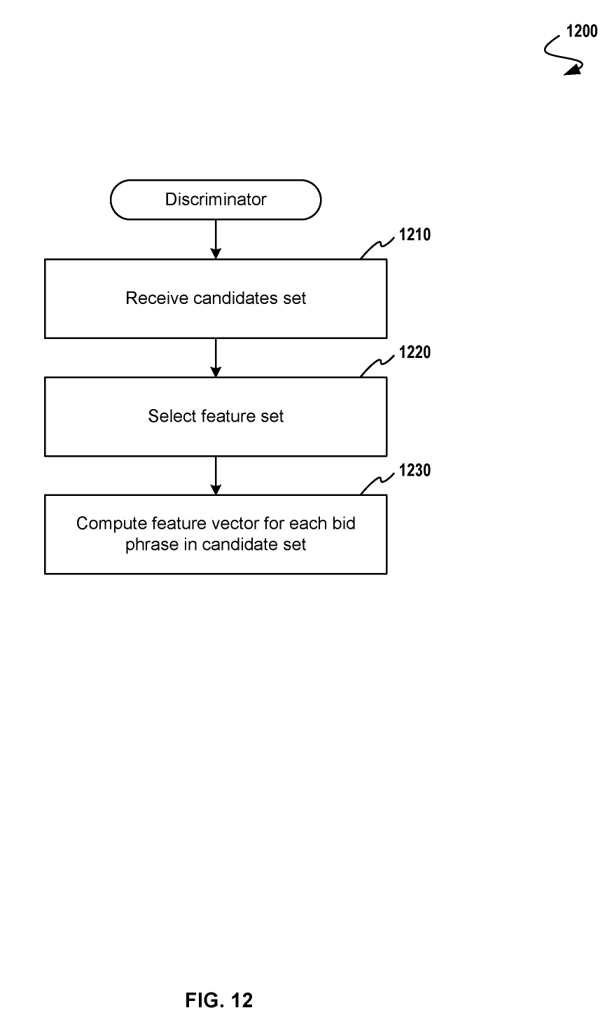

FIG. 12 is a flowchart of a system to perform certain functions of a discrimination system for automatic generation of bid phrases for online advertising. As an option, the present system 1200 may be implemented in the context of the architecture and functionality of the embodiments described herein. Of course, however, the system 1200 or any operation therein may be carried out in any desired environment. As shown, system 1200 comprises a series of operations used in the ranking of a set of bid phrases using a discrimination system. The series of operations may commence by receiving a candidate set (see operation 1210) and compute a feature vector for each bid phrase in the candidate set (see operation 1230). In another operation, possibly in an offline/static operation, feature sets are selected and computational models for the selected feature sets are determined (see operation 1220).

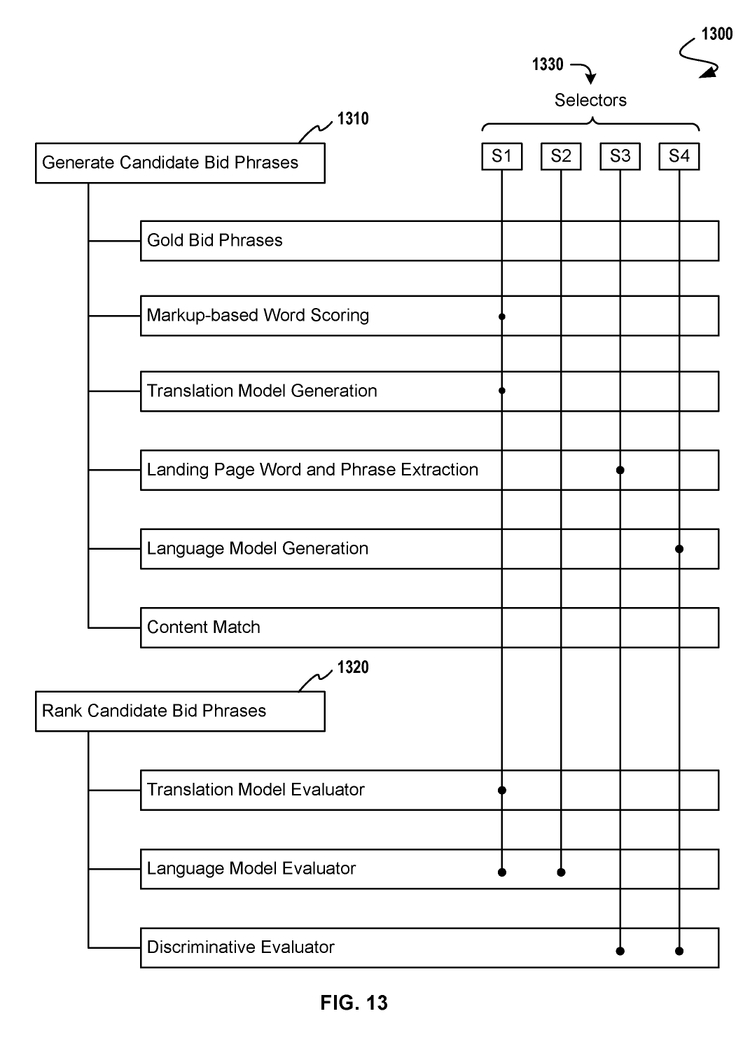

FIG. 13 is a depiction of a selector used in development of systems and methods for automatic generation of bid phrases for online advertising, according to one embodiment. As shown, the system 1300 depicts a hierarchical view of various techniques used in the generation of candidate bid phrases 1310, and a hierarchical view of various techniques used in the ranking of candidate bid phrases 1320. Additionally, system 1300 shows a group of selectors 1330 (S1, S2, S3, and S4). The depicted selectors are purely exemplary, and other combinations and permutations are envisioned and possible. One such selector, S1, implements generation operations using markup-based word scoring plus translation model generation (as indicated by the dots). Similarly, selector S1 implements ranking operations using a translation model evaluator plus a language model evaluator.

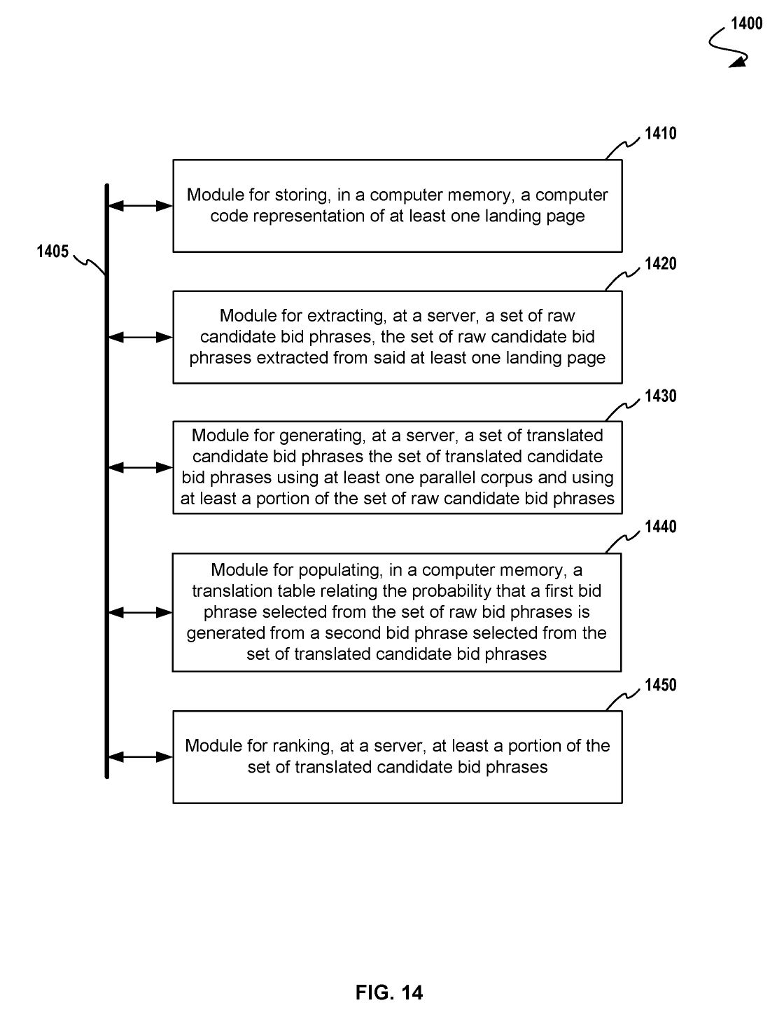

FIG. 14 is a block diagram of a system for automatic generation of bid phrases for online advertising, in accordance with one embodiment of the invention. As an option, the present system 1400 may be implemented in the context of the architecture and functionality of the embodiments described herein. Of course, however, the system 1400 or any operation therein may be carried out in any desired environment. As shown, system 1400 includes a plurality of modules, each connected to a communication link 1405, and any module can communicate with other modules over communication link 1405. The modules of the system can, individually or in combination, perform method steps within system 1400. Any method steps performed within system 1400 may be performed in any order unless as may be specified in the claims. As shown, system 1400 implements a method for online advertising, the system 1400 comprising modules for: storing, in a computer memory, a computer code representation of at least one landing page 616 (see module 1410); extracting, at a server, a set of raw candidate bid phrases 640, the set of raw candidate bid phrases extracted from the at least one landing page (see module 1420); generating, at a server, a set of translated candidate bid phrases 644 the set of translated candidate bid phrases using at least one parallel corpus 642 and using at least a portion of the set of raw candidate bid phrases (see module 1430); populating, in a computer memory, a translation table 650 relating the probability that a first bid phrase selected from the set of raw bid phrases is generated from a second bid phrase selected from the set of translated candidate bid phrases (see module 1440); and ranking, at a server, at least a portion of the set of translated candidate bid phrases (see module 1450).

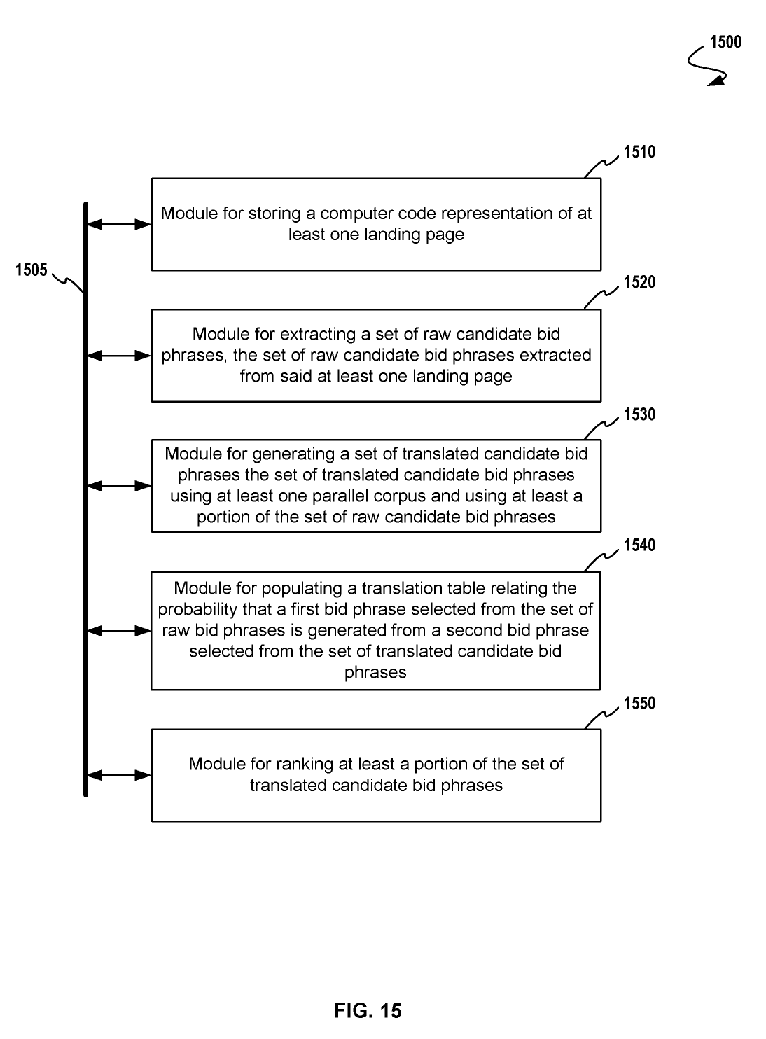

FIG. 15 is a block diagram of a system for automatic generation of bid phrases for online advertising, in accordance with one embodiment of the invention. As an option, the present system 1500 may be implemented in the context of the architecture and functionality of the embodiments described herein. Of course, however, the system 1500 or any operation therein may be carried out in any desired environment. As shown, system 1500 includes a plurality of modules, each connected to a communication link 1505, and any module can communicate with other modules over communication link 1505. The modules of the system can, individually or in combination, perform method steps within system 1500. Any method steps performed within system 1500 may be performed in any order unless as may be specified in the claims. As shown, system 1500 implements an advertising server network for online advertising, the system 1500 comprising modules for: storing a computer code representation of at least one landing page (see module 1510); extracting a set of raw candidate bid phrases, the set of raw candidate bid phrases extracted from the at least one landing page (see module 1520); generating a set of translated candidate bid phrases the set of translated candidate bid phrases using at least one parallel corpus and using at least a portion of the set of raw candidate bid phrases (see module 1530); populating a translation table relating the probability that a first bid phrase selected from the set of raw bid phrases is generated from a second bid phrase selected from the set of translated candidate bid phrases (see module 1540); and ranking at least a portion of the set of translated candidate bid phrases (see module 1550).

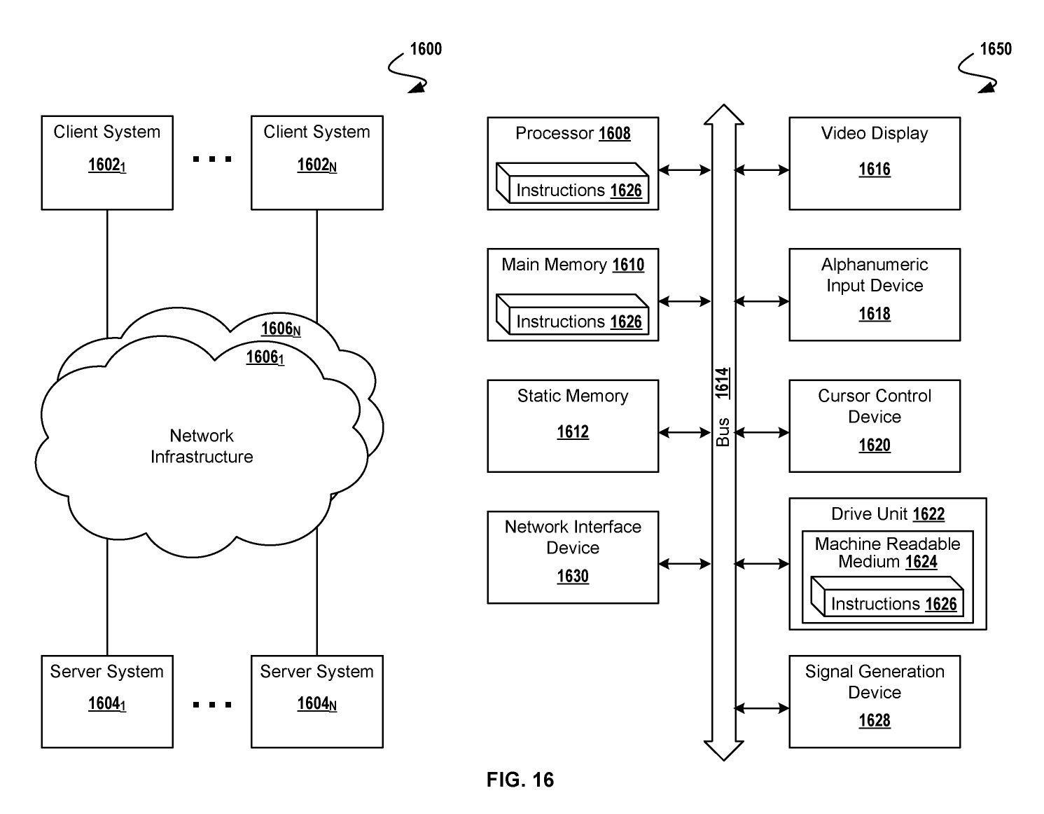

FIG. 16 is a diagrammatic representation of a network 1600, including nodes for client computer systems 1602₁ through 1602_{N}, nodes for server computer systems 1604₁ through 1604_{N}, nodes for network infrastructure 1606₁ through 1606_{N}, any of which nodes may comprise a machine 1650 within which a set of instructions for causing the machine to perform any one of the techniques discussed above may be executed. The embodiment shown is purely exemplary, and might be implemented in the context of one or more of the figures herein.

Any node of the network 1600 may comprise a general-purpose processor, a digital signal processor (DSP), an application specific integrated circuit (ASIC), a field programmable gate array (FPGA) or other programmable logic device, discrete gate or transistor logic, discrete hardware components, or any combination thereof capable to perform the functions described herein. A general-purpose processor may be a microprocessor, but in the alternative, the processor may be any conventional processor, controller, microcontroller, or state machine. A processor may also be implemented as a combination of computing devices (e.g. a combination of a DSP and a microprocessor, a plurality of microprocessors, one or more microprocessors in conjunction with a DSP core, or any other such configuration, etc).

In alternative embodiments, a node may comprise a machine in the form of a virtual machine (VM), a virtual server, a virtual client, a virtual desktop, a virtual volume, a network router, a network switch, a network bridge, a personal digital assistant (PDA), a cellular telephone, a web appliance, or any machine capable of executing a sequence of instructions that specify actions to be taken by that machine. Any node of the network may communicate cooperatively with another node on the network. In some embodiments, any node of the network may communicate cooperatively with every other node of the network. Further, any node or group of nodes on the network may comprise one or more computer systems (e.g. a client computer system, a server computer system) and/or may comprise one or more embedded computer systems, a massively parallel computer system, and/or a cloud computer system.

The computer system 1650 includes a processor 1608 (e.g. a processor core, a microprocessor, a computing device, etc), a main memory 1610 and a static memory 1612, which communicate with each other via a bus 1614. The machine 1650 may further include a display unit 1616 that may comprise a touch-screen, or a liquid crystal display (LCD), or a light emitting diode (LED) display, or a cathode ray tube (CRT). As shown, the computer system 1650 also includes a human input/output (I/O) device 1618 (e.g. a keyboard, an alphanumeric keypad, etc), a pointing device 1620 (e.g. a mouse, a touch screen, etc), a drive unit 1622 (e.g. a disk drive unit, a CD/DVD drive, a tangible computer readable removable media drive, an SSD storage device, etc), a signal generation device 1628 (e.g. a speaker, an audio output, etc), and a network interface device 1630 (e.g. an Ethernet interface, a wired network interface, a wireless network interface, a propagated signal interface, etc).

The drive unit 1622 includes a machine-readable medium 1624 on which is stored a set of instructions (i.e. software, firmware, middleware, etc) 1626 embodying any one, or all, of the methodologies described above. The set of instructions 1626 is also shown to reside, completely or at least partially, within the main memory 1610 and/or within the processor 1608. The set of instructions 1626 may further be transmitted or received via the network interface device 1630 over the network bus 1614.

It is to be understood that embodiments of this invention may be used as, or to support, a set of instructions executed upon some form of processing core (such as the CPU of a computer) or otherwise implemented or realized upon or within a machine- or computer-readable medium. A machine-readable medium includes any mechanism for storing or transmitting information in a form readable by a machine (e.g. a computer). For example, a machine-readable medium includes read-only memory (ROM); random access memory (RAM); magnetic disk storage media; optical storage media; flash memory devices; electrical, optical or acoustical or any other type of media suitable for storing information.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A computer-implemented method for automatic generation of bid phrases for online advertising comprising:
storing, in a computer memory, a computer code representation of at least one landing page;
extracting, at a server, a set of raw candidate bid phrases, the set of raw candidate bid phrases extracted from said at least one landing page;
generating, at a server, a set of translated candidate bid phrases that use at least one parallel corpus and use at least a portion of the set of raw candidate bid phrases;
populating, in a computer memory, a translation table relating the probability that a first bid phrase selected from the set of raw bid phrases is generated from a second bid phrase selected from the set of translated candidate bid phrases;
ranking, at a server, at least a portion of the set of translated candidate bid phrases.

2. The method of claim 1, further comprising:
storing, in a computer memory, at least a portion of the set of translated candidate bid phrases.

3. The method of claim 1, wherein the extracting excludes advertiser's hand-crafted bid phrases.

4. The method of claim 1, wherein the extracting selects only the top M percent of the highest weighted words found within a selected markup tag.

5. The method of claim 1, wherein the ranking using a translation model evaluator engine followed by a language model evaluator engine.

6. The method of claim 5, wherein the translation model evaluator is trained using parallel corpora comprising at least one advertisement in combination with at least one landing page.

7. The method of claim 5, wherein the translation model evaluator is trained using parallel corpora comprising at least one raw bid phrase in combination with at least one landing page.

8. The method of claim 1, wherein the ranking using a language model evaluator engine followed by a translation model evaluator engine.

9. The method of claim 8, wherein the language model evaluator is trained using web search query log corpus.

10. The method of claim 9, wherein the language model evaluator uses at least one of, a bigram model, a unigram model, an n-gram model, an m-gram model.

11. The method of claim 1, wherein the extracting includes a weighted feature vector converted from at least one of, a landing page, an advertisement.

12. The method of claim 11, further comprising calculating relevance using at least one of, a cosine function, a Jaccard function.

13. The method of claim 1, wherein the extracting includes extracting n-gram word sequences.

14. The method of claim 13, wherein the n-gram word sequence includes a weight vector.

15. The method of claim 1, wherein the generating includes a higher ranking for bid phrases that do not appear in the landing page as compared with bid phrases that do appear in the landing page.

16. The method of claim 1, wherein the generating includes calculating permutations of at least one translated candidate bid phrase from among said translated candidate bid phrases.

17. The method of claim 1, wherein the at least one parallel corpus includes advertisements that point to said at least one landing page.

18. The method of claim 1, wherein the populating includes using a translation model estimate Pr(page|phrase).

19. The method of claim 18, wherein the translation model estimate includes at least one null token.

20. The method of claim 1, wherein the populating includes using a language model estimate Pr(phrase).

21. An advertising server network for automatic generation of bid phrases for online advertising comprising:
a module for storing a computer code representation of at least one landing page;
a module for extracting a set of raw candidate bid phrases, the set of raw candidate bid phrases extracted from said at least one landing page;
a module for generating a set of translated candidate bid phrases the set of translated candidate bid phrases using at least one parallel corpus and using at least a portion of the set of raw candidate bid phrases;
a module for populating a translation table relating the probability that a first bid phrase selected from the set of raw bid phrases is generated from a second bid phrase selected from the set of translated candidate bid phrases;
a module for ranking at least a portion of the set of translated candidate bid phrases.

22. A computer readable medium comprising a set of instructions which, when executed by a computer, cause the computer to generate bid phrases for online advertising the instructions for:
storing, in a computer memory, a computer code representation of at least one landing page;
extracting, at a server, a set of raw candidate bid phrases, the set of raw candidate bid phrases extracted from said at least one landing page;
generating, at a server, a set of translated candidate bid phrases the set of translated candidate bid phrases using at least one parallel corpus and using at least a portion of the set of raw candidate bid phrases;
populating, in a computer memory, a translation table relating the probability that a first bid phrase selected from the set of raw bid phrases is generated from a second bid phrase selected from the set of translated candidate bid phrases;
ranking, at a server, at least a portion of the set of translated candidate bid phrases.
